(19) United States
(12) Patent Application Publication
(10) Pub. No.: US 2023/0385861 A1
(43) Pub. Date: Nov. 30, 2023

(54) DYNAMIC MARKET SEGMENTATION

(71) Applicant: SUZY, INC., New York, NY (US)

(72) Inventors: Jai Ghose, East Hanover, NJ (US); Daniel Ramirez, Brooklyn, NY (US); William Welles Cimarosa, Weston, CT (US); Viral Parmar, Jersey City, NJ (US); Apoorva Srivastava, Millburn, NJ (US); William Shawn Mansfield, Wilmington, NC (US); Matthew Britton, Brooklyn, NY (US); Albert Avi Savar, New York, NY (US); Nicolas Gauchat, Glen Ridge, NJ (US); John Maxwell Kelly, Chicago, IL (US)

(21) Appl. No.: 18/202,112

(22) Filed: May 25, 2023

Related U.S. Application Data
(60) Provisional application No. 63/345,668, filed on May 25, 2022.

(51) Int. Cl. G06Q 30/0204; G06Q 30/0203; G06F 18/23211

(52) U.S. Cl. CPC G06Q 30/0204; G06F 18/23211; G06Q 30/0203

(57) ABSTRACT

One or more embodiments perform dynamic market segmentation as described in further detail herein. Dynamic market segmentation may include machine learning. Dynamic market segmentation may leverage respondents' responses to survey questions, which may be organized into a progression of survey modules designed to improve market segmentation.

### RELATED APPLICATIONS

This application claims the benefit of U.S. Provisional Patent Application Ser. No. 63/345,668, titled “DYNAMIC MARKET SEGMENTATION” and filed May 25, 2022, which is hereby incorporated by reference in its entirety.

### BACKGROUND

Market segmentation is the process of dividing a target market into multiple groups (“segments”), each group having one or more distinct characteristics and/or combinations of characteristics. Marketing efforts can then be tailored to each market segment. Traditional market segmentation approaches are performed manually, using only traditional multivariate approaches using manual programs, such as IBM Statistical Product and Service Solutions (SPSS).

Approaches described in this section have not necessarily been conceived and/or pursued prior to the filing of this application. Accordingly, unless otherwise indicated, approaches described in this section should not be construed as prior art.

### TECHNICAL FIELD

The present disclosure relates generally to market segmentation.

### SUMMARY

One or more embodiments perform dynamic market segmentation as described in further detail herein. Dynamic market segmentation may include machine learning. Dynamic market segmentation may leverage respondents' responses to survey questions, which may be organized into a progression of survey modules designed to improve market segmentation.

One or more embodiments described in this Specification and/or recited in the claims may not be included in this General Overview section.

### BRIEF DESCRIPTION OF THE DRAWINGS

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIG. 1 illustrates an example system, apparatuses, computer program products, and associated data structures for use in connection with one or more embodiments.

FIG. 2 illustrates an example method in accordance with one or more embodiments.

FIG. 3 illustrates an example of a survey module using a 7-box scale according to an embodiment.

FIG. 4 illustrates an example structure of an example survey used in conjunction with one or more embodiments.

FIG. 5 illustrates an example method in accordance with one or more embodiments.

FIG. 6 illustrates a graph of example data for use in connection with one or more embodiments.

FIG. 7 illustrates an example of a typing tool benchmarking template according to an embodiment.

FIG. 8 illustrates a graph of example data for use in connection with one or more embodiments.

FIG. 9 illustrates a graph of example data for use in connection with one or more embodiments.

### DETAILED DESCRIPTION

### I. Terms amd Definitions

As used herein, a “market research platform” refers to a system configured to perform market research, including but not limited to: web- and/or application-based surveys, cloud-hosted market research services, etc. Suzy, developed by Suzy, Inc., is an example of a market research platform and includes the CrowdTap application.

As used herein, “machine learning” refers to a subfield of artificial intelligence, which is broadly defined as the capability of a machine to imitate intelligent human behavior. Artificial intelligence systems are used to perform complex tasks in a way that is similar to how humans solve problems. In addition, machine learning can be used to perform operations that are beyond human capabilities, due to the complexity, magnitude, imperceptibility to human senses, innate digital/computerized nature, and/or other properties of the problem at hand.

As used herein, a “Typing Tool” refers to a deliverable for segmentation projects in the form, for example, of an Excel calculator. A typing tool enables segment membership to be estimated for new cases not in the original sample.

As used herein, a “Client Typing Tool” refers to a segment calculator provided by clients to score on the market research platform.

### II. Introduction

One or more embodiments provide an end-to-end solution for a market research platform that provides clients with rapid execution of market research across key audience segments that is statistically sound, cost-effective, and actionable. Techniques described herein minimize the need for human intervention, and accelerate the decision-making process for clients.

One or more embodiments use machine learning to increase the speed and precision of market segmentation performed by a market research platform. Machine learning as described herein can determine top driving agreement statements from survey modules, thus helping to ensure that segment models and typing tool outputs can be used for one or more of:
1. Developing highly accurate personas by minimizing the subjectivity inherent in the segmentation development process.
2. Identifying the top drivers of dependent variables such as brand satisfaction, loyalty, and likelihood to recommend.
3. Providing regular, cost-effective typing tool updates to ensure maximum panel size and diversity via, for example, a Typing Tool weighting template.

In an embodiment, a system includes one or more application programming interfaces (APIs), standardized segmentation survey modules, and typing tool weighting templates. The system provides an end-to-end solution to rapidly produce analyses and scoring algorithms to identify target audience segments.

### III. High-Level Process Flow

In an embodiment, market research projects start and end on a market research platform, providing clients with seamless market research execution. Techniques described herein minimize human error during the segment build process, leave clients with more time to fully flesh out personas, and can be quickly set up on a market research platform for additional research. Recommendations provided are dynamic and can be adjusted based on the desired predictor—e.g., Likelihood to Purchase, Brand Purchased Most Often, etc.

### IV. Segmentation Engine

In an embodiment, a segmentation engine as described herein minimizes the need for manual intervention, which significantly reduces the chance for human error and shortens the turnaround time for any segmentation. Once a project has been set up via the user interface, segmentation and other analytical offerings can be executed at will. Typing tool refreshes can be automatically scheduled that feed into other do-it-yourself (DIY) client research.

Unlike typing tools that rely on excel calculators, a typing tool according to one or more embodiments is entirely built into the platform for on-demand execution. The agility of this approach helps ensure that panelists are fresh, relevant, and precise. In an embodiment, using an API for data retrieval into the segmentation engine allows for an additional layer of security, because clients can be partitioned via private encryption keys.

One or more embodiments include a data repository. A data repository is any type of storage unit and/or device (e.g., a file system, database, collection of tables, or any other storage mechanism) for storing data. A data repository may include multiple different storage units and/or devices. The multiple different storage units and/or devices may or may not be of the same type or located at the same physical site. Further, a data repository may be implemented or may execute on the same computing system as one or more other components of the system. Alternatively or additionally, a data repository may be implemented or executed on a computing system separate from one or more other components of the system. A data repository may be logically integrated with one or more other components of the system. Alternatively or additionally, a data repository may be communicatively coupled to one or more other components of the system via a direct connection or via a network.

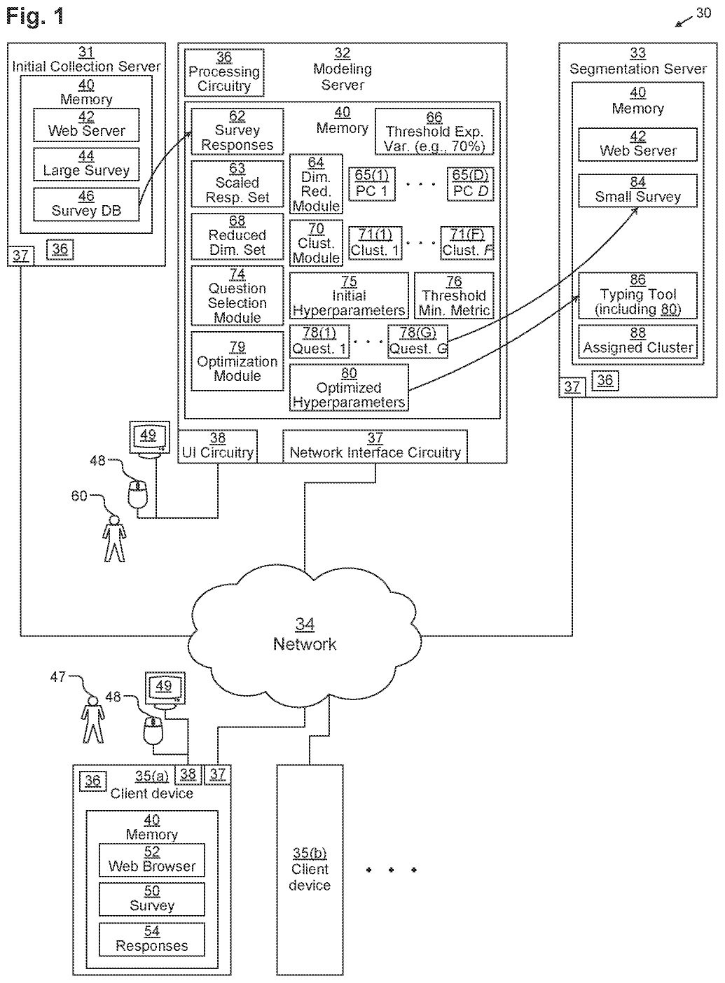

FIG. 1 depicts an example system for use in connection with various embodiments. System 30 includes a set of servers 31, 32, 33 connected to a set of client devices 35 (depicted as client devices 35(1), 35(2), . . . ) via a network 34.

Network 34 may be any kind of communications network or set of communications networks, such as, for example, a LAN, WAN, SAN, the Internet, a wireless communication network, a virtual network, a fabric of interconnected switches, etc.

Initial collection server 31 is configured to collect responses from users 47 operating client devices 35 to a large survey 44. Large survey 44 includes a large number (e.g., more than of questions. Initial collection server 31 provides the survey responses 62 to modeling server 32, which is configured to generate a subset of the questions from the large survey (the subset being depicted as questions 78(1), . . . , 78(G)) to be used by segmentation server 33 as part of a small survey 84. Modeling server 32 is also configured to generate a set of optimized hyperparameters 80 to be used by segmentation server 33 as part of a typing tool 86 in order to segment responses from users 47 to the small survey 84. Examples hyperparameters may include how many trees to use, how many leaves to use per tree, the maximum tree depth, a number of estimators, a choice of objective function, a maximum (Sₘₐₓ) number G of questions 78, etc.

In some embodiments (not depicted), initial collection server 31 and modeling server 32 may both be the same machine. In some embodiments (not depicted), modeling server 32 and segmentation server 33 may both be the same machine. In some embodiments (not depicted), initial collection server 31 and segmentation server 33 may both be the same machine. In some embodiments (not depicted), initial collection server 31, modeling server 32, and segmentation server 33 may all be the same machine.

In some embodiments (not depicted), the functionality of one or more of initial collection server 31, modeling server 32, and segmentation server 33 may be implemented in a cloud configuration rather than as a single machine.

Both client devices 35 and servers 31, 32, 33 may be any kind of computing device, such as, for example, a personal computer, laptop, workstation, server, enterprise server, tablet, smartphone, etc. Both client devices 35 and servers 31, 32, 33 include processing circuitry 36, network interface circuitry 37, and memory 40. In addition, client devices 35 and modeling server 32 also include user interface (UI) circuitry 38 for connecting to a UI input device 48 and a display device 49. In some embodiments (not depicted), initial collection server 31 and/or segmentation server 33 may also include UI circuitry 38 for connecting to a UI input device 48 and a display device 49. Client devices 35 and servers 31, 32, 33 may also include various additional features as is well-known in the art, such as, for example, interconnection buses, etc.

Processing circuitry 36 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 37 may include one or more Ethernet cards, cellular modems, Fibre Channel (FC) adapters, InfiniBand adapters, wireless networking adapters (e.g., Wi-Fi), and/or other devices for connecting to a network 34.

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 36 as well as various data.

UI circuitry 38 may include any circuitry needed to communicate with and connect to one or more user input devices 48 and display screens 49. UI circuitry 38 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 49 may be any kind of display, including, for example, a CRT screen, LCD screen, LED screen, etc. Input device 48 may include a keyboard, keypad, mouse, trackpad, trackball, pointing stick, joystick, touchscreen (e.g., embedded within display screen 49), microphone/voice controller, etc. In some embodiments, instead of being external to client devices 35 or modeling server 32, the input device 48 and/or display screen 49 may be embedded within the client devices 35 and/or modeling server 32 (e.g., a cell phone or tablet with an embedded touchscreen).

Memory 40 of initial collection server 31 stores a web server 42, a large survey 44, and a survey database (DB) 46. Web server 42 operates on the processing circuitry 36 of initial collection server 31 to serve one or more web pages embodying the large survey 44 to a web browser 52 operating on client devices 35 and to receive responses 54 to the questions of the large survey 44 from the client devices 35. Initial collection server 31 stores these responses 54 within the survey DB 46.

Memory 40 of each client device 35 stores web browser 52, a received survey 50, and responses 54 to the questions of the survey 50 as received from a user 47 operating the one or more user input devices 48 and display screens 49. Web browser 52 operates on the processing circuitry 36 of a client 35 to receive and display one or more web pages embodying a survey 50 (e.g., large survey 44 or small survey 84) on display screen 49 and to receive the responses 54 from the client 47 using input device 48.

Memory 40 of modeling server 32 stores a dimension reduction module 64, a clustering module 70, a question selection module 74, and an optimization module 79, which are configured to operate on processing circuitry of modeling server 32. Dimension reduction module 64 is configured to take survey responses 62 (obtained from the survey DB 46 of initial collection server 31), created a scaled response set 63 from the survey responses 62, and to generate a reduced dimensionality set 68 having fewer dimensions than the survey responses 62 (or scaled response set 63). The survey responses 62 include responses from various users 47 (let's assume U users) to a set of D questions (e.g., D=200), effectively creating a D-dimensional space with U data points. Reduced dimensionality set 68 is an E-dimensional space with U data points, with E being significantly smaller than D (e.g., E=50, or roughly ¼ of D). In some embodiments, dimension reduction module 64 creates reduced dimensionality set 68 by performing Principal Component Analysis (PCA) on the D-dimensional survey responses 62, yielding D principal components (PCs) 65 (depicted as PCs 65(1), . . . , 65(D)), which are eigenvectors. When dimension reduction module 64 performs the dimension reduction operations, it may make reference to a threshold explained variance 66 (e.g., 70%), reducing the dimensionality until the explained variance drops to the threshold explained variance 66.

Clustering module 70 is configured to perform clustering (e.g., K means Clustering) on the reduced dimensionality set 68 (or, in some embodiments, directly on the D-dimensional survey responses 62), thereby dividing the U data points into a set of F clusters 71 (depicted as clusters 71(1), . . . , 71(F)). Question selection module 74 is configured to select a subset of the original D questions from the large survey 44, yielding a new set of questions 78 (depicted as questions 78(1), . . . , 78(G)). Question selection module 74 may perform this selection using a gradient-boosting framework for machine learning such as LightGBM (LGBM) developed by Microsoft Corp., with reference to an initial set of hyperparameters 75 and a threshold minimum metric 76. Optimization module 79 is configured to perform hyperparameter optimization to yield an optimized set of hyperparameters 80, which can be used to assign any set of responses to the G questions 78 from a single user 47 to a particular cluster 71.

An administrator 60 may communicate with modeling server 32 to oversee its operation via UI input device 48 and display device 49. In some embodiments (not depicted), administrator 60 may operate the UI input device 48 and display device 49 on a remote computing device that connects to modeling server 32 over the network 34 instead. In some embodiments, administrator 60 may configure various options employed by dimension reduction module 64, clustering module 70, question selection module 74, and optimization module 79 in order to influence the outputs 78, 80.

Memory 40 of segmentation server 33 stores a web server 42, a small survey 84, and a typing tool 86. Web server 42 operates on the processing circuitry 36 of initial collection server 31 to serve one or more web pages embodying the small survey 84 to a web browser 52 operating on client devices 35 and to receive responses 54 to the questions of the small survey 84 from the client devices 35. Small survey 84 is generated using the G questions 78. Segmentation server 33 uses typing tool 86 to assign the responses 54 from each user 47 to a particular assigned cluster 88 drawn from the F clusters 71. Typing tool 86 is generated using the optimized hyperparameters 80.

Memory 40 may also store various other data structures used by the OS, web server 42, web browser 52, dimension reduction module 64, clustering module 70, question selection module 74, optimization module 79, and various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 31, 32, 33, 35 is powered off. The OS, web server 42, web browser 52, dimension reduction module 64, clustering module 70, question selection module 74, optimization module 79, and various other applications and drivers are typically stored in this persistent storage portion of memory 40 so that they may be loaded into a system portion of memory 40 upon a system restart or as needed. The OS, web server 42, web browser 52, dimension reduction module 64, clustering module 70, question selection module 74, optimization module 79, and various other applications and drivers, when stored in non-transitory form either in the volatile or persistent portion of memory 40, each form a computer program product. The processing circuitry 36 running one or more applications thus forms a specialized circuit constructed and arranged to carry out the various processes described herein.

### V. Segmentation Process

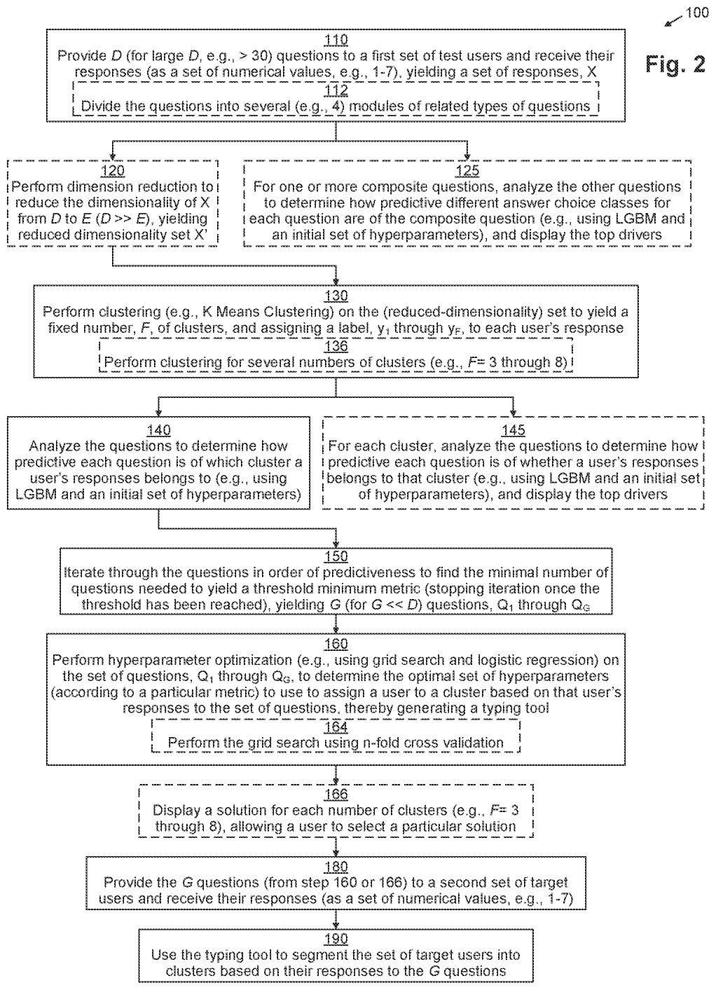

FIG. 2 illustrates an example method 100 performed by a system 30 for performing dynamic segmentation of users 47. It should be understood that any time a piece of software (e.g., OS, web server 42, web browser 52, dimension reduction module 64, clustering module 70, question selection module 74, optimization module 79, etc.) is described as performing a method, process, step, or function, what is meant is that a computing device (e.g., client device 35 or server 31, 32, 33) on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order. Dashed lines indicate that a step or sub-step is either optional or representative of alternate embodiments or use cases.

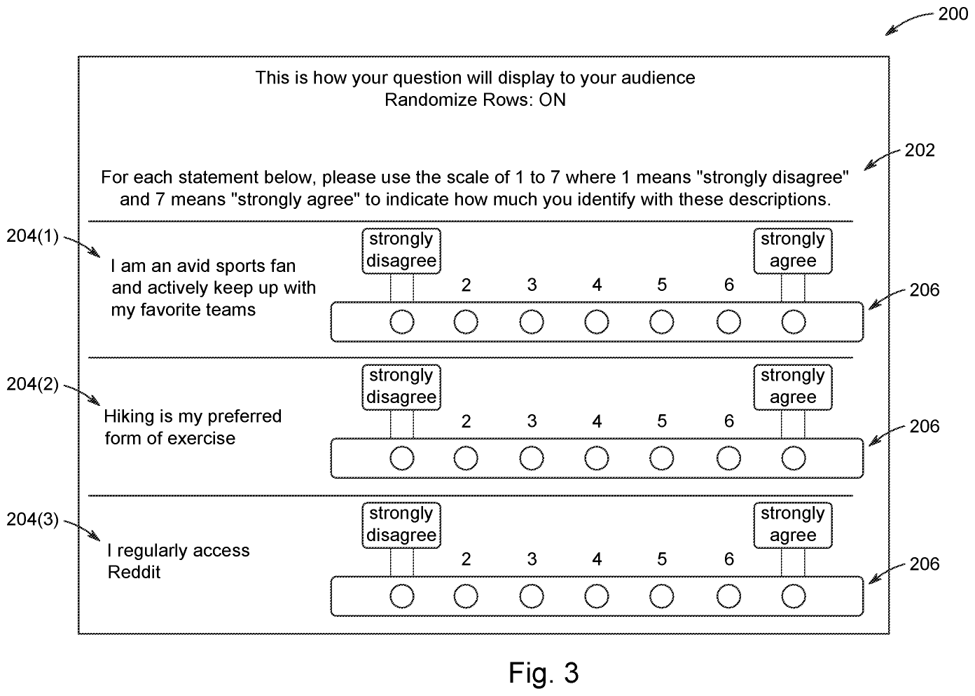

In step 110, initial collection server 31 provides D questions from a large survey 44 to a first set of users 47 (i.e., test users), receiving responses 54 back from each test user, yielding a set of responses stored in survey DB 46. Survey DB 46 may include D columns (one for each question) plus any additional columns needed to identify each user 47. As step 110 continues to perform, the number of rows in survey DB 46 increases. Initial collection server 31 may then provide access to survey DB 46 to modeling server 32 so that modeling server 32 can obtain the survey responses 62. In an embodiment, a data collection process for Dynamic Marketing Segmentation uses several consumer-facing survey modules that are targeted towards users of a product category or brand set relevant to the end client. Each survey module includes questions designed around agreement and importance scales, through which a respondent is asked to indicate how much they “agree/disagree” or to indicate “importance” across a range of category, product, and brand attribute statements. Scales may be based on, for example, a 7-Box scale with 1 being the lowest value (strongly disagree/not at all important) and 7 being the highest value (strongly agree/very important). FIG. 3 illustrates an example of a survey module 200 using a 7-box scale 206 according to an embodiment. As depicted, a general prompt 202 provides instructions, and a set of questions 204 (also referred to as statements) (depicted as questions 204(1), 204(2), 204(3)) allows the user 47 to input responses in a response box 206, depicted as a 7-point radio selection box, allowing the user 47 to provide an integer rating on a scale of 1 through 7. It should be understood that 7 discrete choices is only an example. In other embodiments, more or fewer discrete options may be shown or the options may instead be continuous rather than discrete.

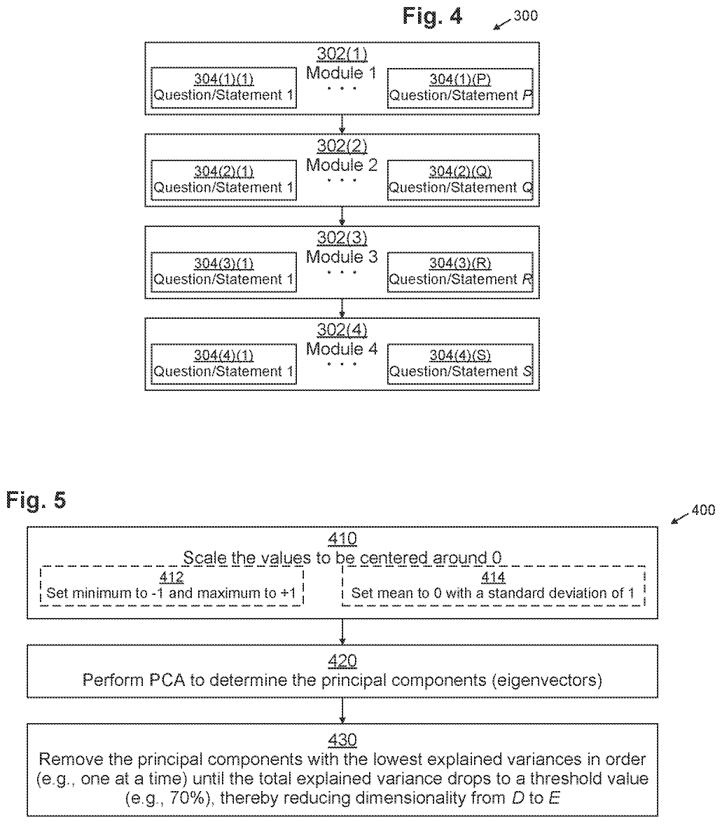

Because large survey 44 may include a very large number of questions (e.g., 200 questions), it may be cumbersome for a user 47 to provide all the answers in a single session. Thus, in optional sub-step 112, as depicted in example arrangement 300 of FIG. 4, the questions 304 may be divided into several modules 302, which are presented sequentially, potentially with breaks in between. For example, arrangement 300 includes 4 modules 302(1), 302(2), 302(3), 302(4). As depicted, first module 302(1) includes P questions 304(1)(1)-304(1)(P), second module 302(2) includes Q questions 304(2)(1)-304(2)(Q), third module 302(3) includes R questions 304(3)(1)-304(3)(R), and fourth module 302(4) includes S questions 304(4)(1)-304(4)(S). Questions 304(1)(1)-304(1)(P) are presented to user 47 as part of module 302(1). Once the user 47 has completed answering questions 304(1)(1)-304(1)(P), the user 47 may either choose to pause until a later time or date or choose to move on to the next module 302(2).

In an embodiment, each survey module 302 is based on attribute statements 304 that leverage 7-box rating scales to minimize respondent fatigue. The survey may be broken into multiple modules 302 (e.g., four modules), each of which can be accessed only after completing the previous module. FIG. 4 illustrates an example of a four-module segmentation survey model 300 according to an embodiment. In an example:
1. Survey Module 302(1) (Category Attitudes and Psychographics) includes questions 304(1) that measure personality traits and attitudes/opinions toward the product category of focus.
2. Survey Module 302(2) (Functional and Emotional Benefits) includes questions 304(2) that measure the importance of different product functional benefits and the way(s) those benefits make the respondent feel (emotional benefits).
3. Survey Module 302(3) (Brand Performance) includes questions 304(3) that measure the performance of the brand used most often against the functional and emotional benefits from Survey Module 2, as well as the various perceptions of what the brand stands for.
4. Survey Module 302(4) (Dependent Variable) includes questions 304(4) that are more difficult for users 47 to answer such as those relating to satisfaction and loyalty. Because these questions 304(4) are difficult to answer, the answers to these questions 304(4) should be correlated with answers 304 from Survey Modules 1-3 in order to improve the accuracy of these questions 304(4).

In some embodiments, operation proceeds with optional step 120. Step 120 is optional because it represents an optimization. In step 120, dimension reduction module 64 performs dimension reduction of the set of survey responses 62, also referred to as set X. Set X has a dimensionality of D. This dimension reduction operation yields a reduced dimensionality set 68, also referred to as set X′. Set X′ has a dimensionality of E, where E is significantly smaller than D. In an example embodiment, D is approximately four times larger than E (e.g., for 200 initial questions 304 in large survey 44, set X′ may have a reduced dimensionality of about 50). In some example embodiments, step 120 may be performed as depicted in Table 1.

Table 1
Dimension Reduction steps

```
Get survey responses, X
Set thresholds PCₘₐₓ and EVₘᵢₙ
Ensure 1 < PCₘₐₓ < < cols(X)
Ensure EVₘᵢₙ ϵ (0, 1)
Normalize X → X_{scaled}
Perform PCA on X_{scaled} with PCₘₐₓ components, X_{scaled} = UΣW_{T}
ExpVar ← ExplainedVariance[UΣW_{T}] with first PCₘₐₓ singular values
k ← PCₘₐₓ
while ExpVar > ExpVarₘᵢₙ and k > 1
  ExpVar ← ExplainedVariance[UΣW_{T}] with first k singular values
  k ← k − 1
Return X′_{scaled} ← UΣW_{T}with first k singular values
```

In some example embodiments, step 120 may include performance of method 400, depicted in FIG. 5. Method 400 includes steps 410 (which may be implemented as sub-step 412 or sub-step 414, depending on the embodiment), 420, and 430.

Operation continues with step 130, in which clustering module 70 performs a clustering operation (e.g., K-means clustering) on the reduced dimensionality set 68 (or on the set of survey responses 62 in embodiments in which step 120 was omitted) to yield a fixed number F of clusters 71. Step 130 also includes assigning a label y₁ through y_{F} to each user's response, depending on which cluster 71 it was assigned to. In some embodiments, the administrator 60 selects the value of F. In other embodiments, as depicted in sub-step 136, multiple values ofF are used, step 130 being performed separately for each value ofF (e.g., for F having all integer values from 3 through 8). In these embodiments, all of steps 140, 150, 160 are repeated for each value ofF as well. In some example embodiments, step 130 may be performed as depicted in Table 2.

TABLE 2
Clustering steps

Get transformed data, X′_{scaled}
Set cₘₐₓ ϵ N
for k = 1...cₘₐₓ
Perform clustering until k labels are generated
Assign label cᵢ ϵ [1, cₘₐₓ] to the ith respondent
Return X and yₖ, the labels corresponding to the k cluster solution

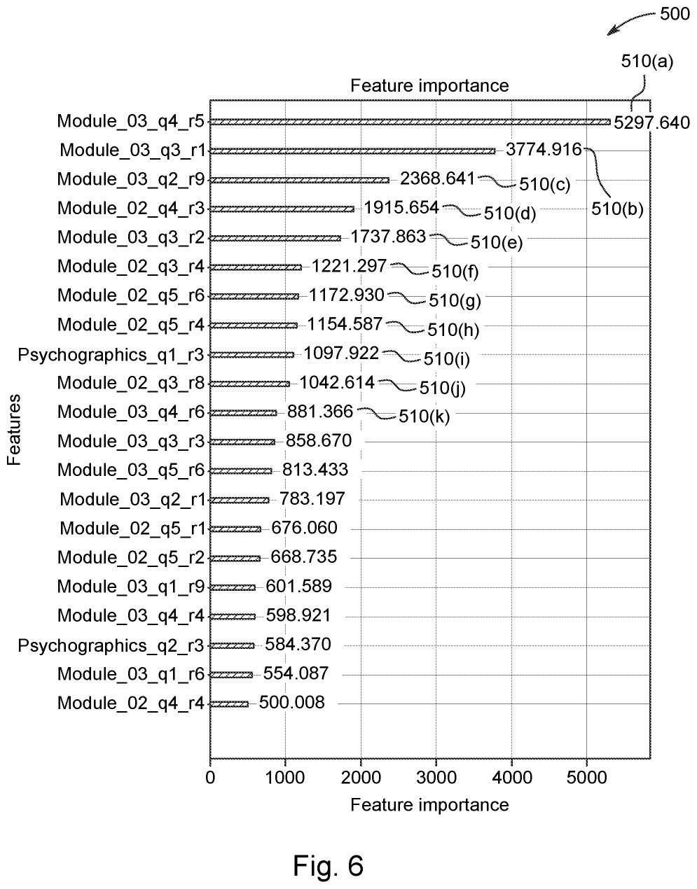

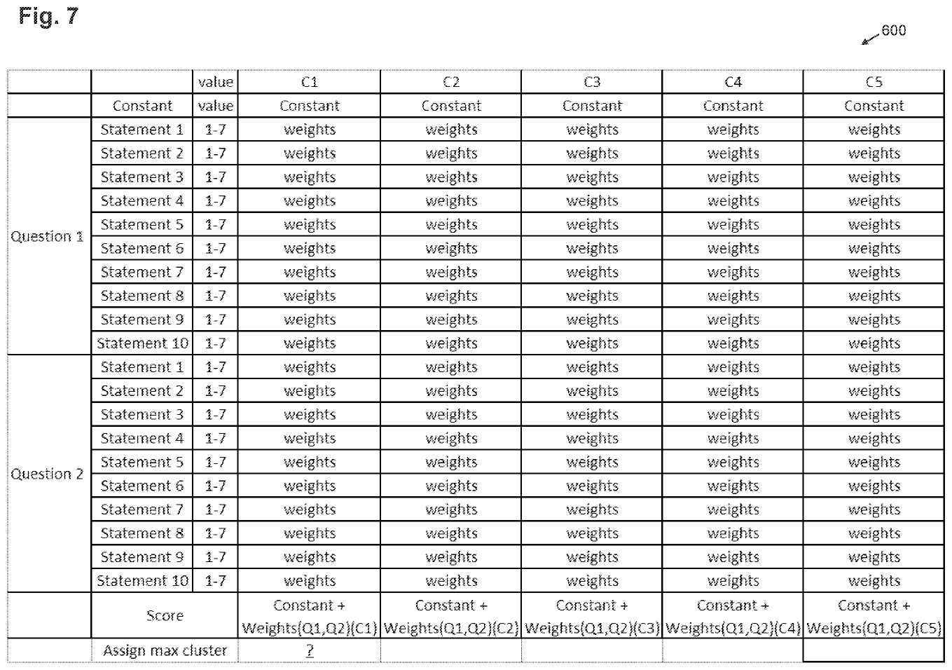

Operation continues with step 140, in which question selection module 70 analyzes the questions 304 of the large survey 44 to determine how predictive each question 304 is of which cluster 71 a user's responses belongs to. Question selection module 74 may perform this selection using a gradient-boosting framework for machine learning, such as LGBM, with reference to an initial set of pre-selected hyperparameters 75. FIG. 6 depicts an example bar graph 500 of a feature importance score 510 generated by the question selection module 70 for various questions 304 of the large survey 44. For example, as depicted, question Module_03_q4_r5 has a feature score 510(a) of 5297.64, question Module_03_q3_r1 has a feature score 510(b) of 3774.916, and question Module_03_q2_r9 has a feature score 510(c) of 2368.641.

Operation continues with step 150, in which question selection module 70 iterates through the questions 304 in order of their predictiveness (from step 140) to find the minimal number of questions 78 needed to yield a threshold minimum metric 76, stopping the iteration once the threshold minimum metric 76 has been reached. Step 150 yields G questions 78, with G being significantly smaller than D (e.g., approximately four times smaller). The set of questions 78(1), . . . , 78(G) defines small survey 84. With reference to FIG. 6, question selection module begins the iteration with question Module_03 _q4_r5 since it has a highest feature score 510(a), then progressing on to question Module_03_q3_r1 since it has a next highest feature score 510(b), with iteration progressing up to Module_03_q4_r6 with feature score (k), upon which the iteration breaks, the threshold minimum metric 76 having been reached. In some example embodiments, steps 140, 150 may be performed as depicted in Table 3.

TABLE 3
Question Selection steps

```
Get preprocessed data, X, and labels, y
Set LGBM hyperparameters
Set sₘₐₓ ϵ N
Set scoreₘᵢₙ ϵ (0, 1)
Ensure sₘₐₓ ϵ [1, cols(X))
Fit LGBM(X, y, hyperparameters)
Get test score of the LGBM fit
Set score_{curr} to the current test score
Get top n statements via importance (gain)
for i in 1...sₘₐₓ
  Get the top i columns of X_{reduced}
  Fit LGBM(X_{reduced}, y, hyperparameters)
  Get test score of the LGBM fit, score_{curr}
  if score_{curr} > scoreₘᵢₙ
    break
Return Return top i of the n most importance statements
```

Operation continues with step 160, in which optimization module 79 performs an optimization operation (e.g., using a grid search and logistic regression over a space of possible hyperparameter values, particularly, in a particular example, across penalty, class weight, and strength of regularization) on the set of questions 78(1), . . . , 78(G) to determine an optimized set of hyperparameters 80 to use to assign a user 47 to a cluster 71 based on that user's responses to the set of questions 78, thereby generating a typing tool 86. In some embodiments, step 160 includes sub-step 164, in which performing the grid search using logistic regression includes using n-fold cross validation (e.g., 5-fold cross validation). In some example embodiments, step 160 may be performed as depicted in Table 4.

TABLE 4
Optimization steps

```
Get preprocessed data, X, and labels, y
Set Logistic Regression hyperparameter grid
Set Desired scoring method
for every possible combination of hyperparameters
  Fit LogisticRegression(X, y, hyperparameters)
  Compute score via n fold cross validation
Return Logistic Regression fit that maximizes score
```

In embodiments in which step 130 included sub-step 136, operation proceeds with step 166. In step 166, a different solution is presented to the administrator 60 for each number F of clusters 71 (e.g., for each of F=3 through 8), to allow the administrator 60 to select which solution to utilize.

In step 180, web server 42 operating on segmentation server 32 provides the G questions 78 from small survey 84 to a second set of users 47 (i.e., target users), receiving responses 54 back from each target user. Then, in step 190, segmentation server uses the typing tool 86 to segment the target users into the clusters 71 based on their responses to the G questions 78.

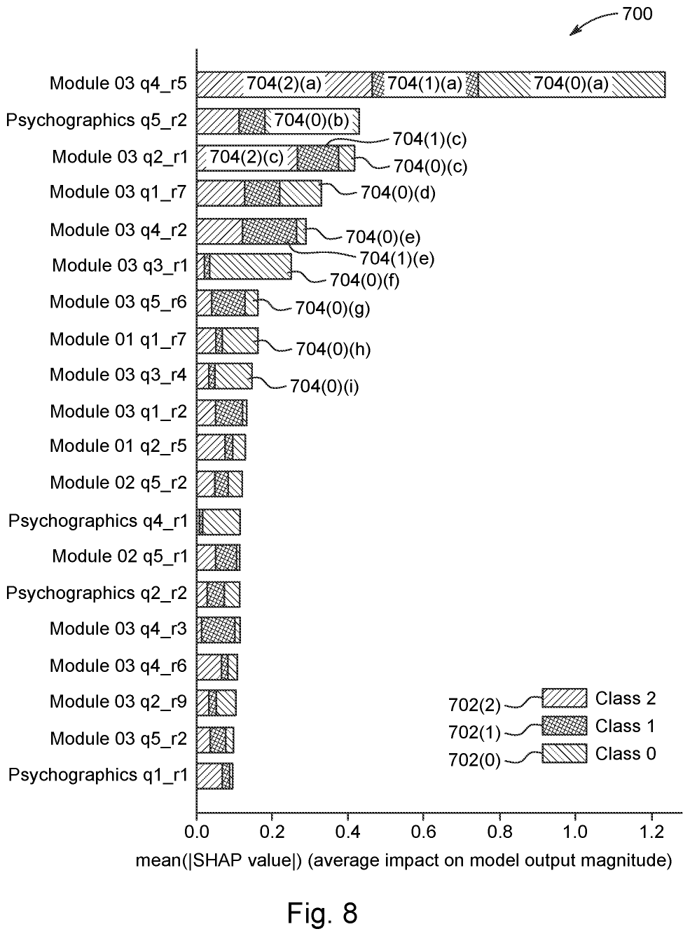

In some embodiments, optional step 125 may be performed in parallel with step 120 (or at any time later). In step 125, for one or more composite questions (e.g., a question 304(4) that was presented within module 302(4)), modeling server 32 analyzes the other questions 304 to determine how predictive different answer choice classes for each question 304 are of the composite question (e.g., using LGBM and an initial set of hyperparameters 75), and displays the top drivers to administrator 60. In an embodiment, answer choices from the 7-box scheme are assigned to particular answer classes. For example, choices 1-2 are assigned to a “low” class, such as class 0 702(0) from FIG. 8; choices 3-5 are assigned to a “middle” class, such as class 1 702(1) from FIG. 8; and choices 6-7 are assigned to a “high” class, such as class 2 702(2) from FIG. 8. FIG. 8 depicts an example graph 700 of this composite driver analysis, such as may be displayed to administrator 60. As depicted in FIG. 8, high answers (6-7) to question Module 03 q4_r5 (depicted in graph portion 704(2)(a)) and low answers (1-2) to question Module 03_q4_r5 (depicted in graph portion 704(0)(a)) are especially strong drivers of a composite question, while middle answers (3-5) to question Module 03 q4_r5 (depicted in graph portion 704(1)(a)), low answers to question Psychographics q5_r2 (depicted in graph portion 704(0)(b)), high answers to question Module 03 q2_r1 (depicted in graph portion 704(2)(c)), and low answers to question Module 03 q3_r1 (depicted in graph portion 704(0)(f)) are moderately strong drivers of that composite question. In some embodiments, Shapley values (SHAP scores) are used in performing this step. In some example embodiments, step 125 may be performed as depicted in Table 5.

TABLE 5
Modeling Drivers steps

```
Get preprocessed data, X, and labels, y
Set LGBM hyperparameters
Set sₘₐₓ ϵ N
Ensure sₘₐₓ ϵ [1, cols(X))
Fit LGBM(X, y, hyperparameters)
Compute SHAP scores of the LGBM fit
for c ϵ unique(y)
  Get top sₘₐₓ | SHAP scores | for c
  Get relevant exogenous variables (corresponding columns)
Return Top sₘₐₓ columns for each class label in y
```

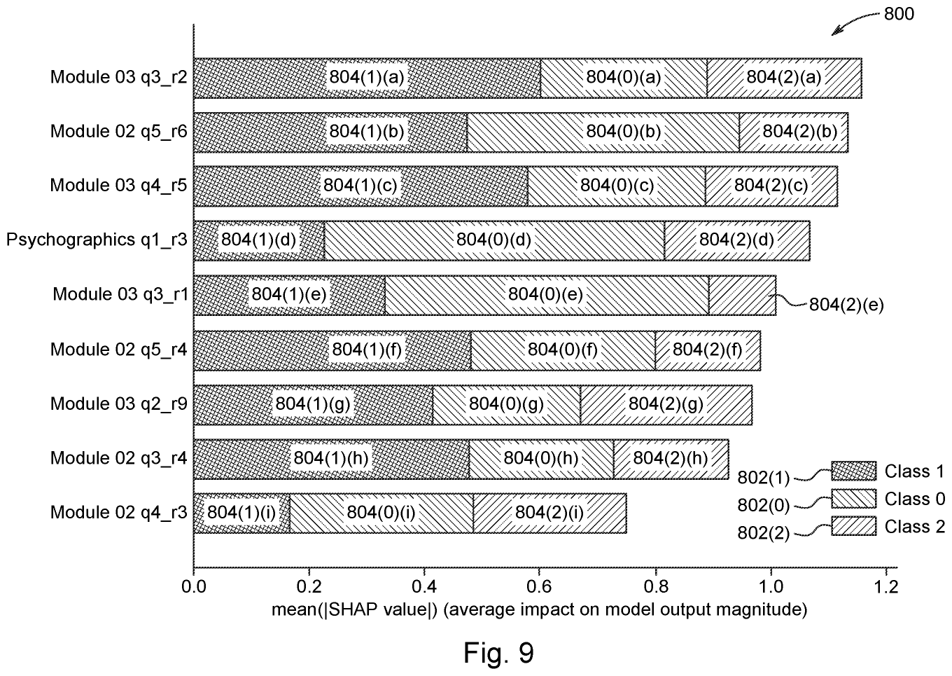

In some embodiments, optional step 145 may be performed in parallel with step 140 (or at any time later). In step 145, for each cluster 71(X), modeling server 32 analyzes the questions 304 to determine how predictive each question 304 is of whether a user's responses belongs to that cluster 71(X) (e.g., using LGBM and an initial set of hyperparameters 75), and displays the top drivers to administrator 60. As depicted in example graph 800 of FIG. 9 (such as may be displayed to administrator 60), question Module 03 q3_r2 is highly predictive of class 1 802(1) (e.g., cluster 71(2)) (depicted in graph portion 804(1)(a)), and moderately predictive of class 0 802(0) (e.g., cluster 71(1)) (depicted in graph portion 804(0)(a)) and class 2 802(2) (e.g., cluster 71(3)) (depicted in graph portion 8042)(a)). As another example, question Module 03 q3_r1 is weakly predictive of class 2 802(2) (e.g., cluster 71(3)) (depicted in graph portion 804(2)(e)), and question Module 02 q4_r3 is weakly predictive of class 1 802(1) (e.g., cluster 71(2)) (depicted in graph portion 804(1)(i)). In some embodiments, Shapley values (SHAP scores) are used in performing this step.

Techniques as described herein provide improved segmentation over conventional approaches. These improvements include increased speed, reduced memory requirements, portability, and more accurate performance. Conventional approaches typically achieve only 60-70% accuracy, while improved approaches as described herein typically achieve an accuracy of The techniques described herein are able to perform segmentation approximately 10 times faster than conventional approaches.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

What is claimed is:

1. A method performed by a set of one or more computing devices for dynamic segmentation, the method comprising:
performing a clustering operation on a set of answers to a first survey from a first plurality of users, the first survey including a first plurality of questions, the clustering operation yielding a plurality of clusters to which the first plurality of users may be assigned;
performing a fit operation on the set of answers to the first survey, yielding a prediction score for each question of the first plurality of questions, the prediction score for each question indicating how predictive answers to that question are towards which cluster of the plurality of clusters a user's responses are;
iterating through the first plurality of questions in order of their prediction scores, beginning with a question having a highest prediction score of the first plurality of questions, and computing a metric for how well a set of questions including all questions already iterated over predicts assignments to the plurality of clusters, stopping iteration once the metric exceeds a threshold minimum metric, yielding a second plurality of questions, the second plurality of questions being fewer than the first plurality of questions;
performing a hyperparameter optimization operation to determine an optimal set of hyperparameters to use to assign membership of a user to a cluster of the plurality of clusters based on that user's answers to the second plurality of questions; and
using the optimal set of hyperparameters to assign membership of a user from a second plurality of users to a cluster of the plurality of clusters based on that user's answers to the second plurality of questions in a second survey.

2. The method of claim 1 wherein performing the fit operation includes operating a gradient-boosting framework for machine learning using an initial set of hyperparameters.

3. The method of claim 1 wherein performing the hyperparameter optimization operation includes performing a grid search using logistic regression over a space of possible hyperparameter values.

4. The method of claim 3 wherein performing the grid search using logistic regression includes using n-fold cross validation.

5. The method of claim 1 wherein:
the method further comprises performing a dimension reduction operation on the set of answers to generate a reduced dimensionality data set, the set of answers having a first dimensionality equal to the first plurality of questions, and the reduced dimensionality data set having a second dimensionality less than the first dimensionality; and
performing the fit operation on the set of answers to the first survey includes performing the fit operation on the reduced dimensionality data set as representative of the set of answers.

6. The method of claim 1 wherein the method further comprises administering the first survey to the first plurality of users, the first survey being divided into a plurality of modules, each module of the plurality of modules including a different subset of the first plurality of questions, wherein administering the first survey to a user of the first plurality of users includes:
sending the questions included within a first module of the plurality of modules to the user;
in response to sending the questions included within the first module, receiving answers to the questions included within the first module from the user;
in response to receiving answers to the questions included within the first module from the user, sending the questions included within a second module of the plurality of modules to the user; and
in response to sending the questions included within the second module, receiving answers to the questions included within the second module from the user.

7. The method of claim 1 wherein the method further comprises:
for a first question of the plurality of questions, performing another fit operation on the set of answers to the first survey, yielding another prediction score for each of a plurality of answer classes for each question of the first plurality of questions aside from the first question, the other prediction score for each such question indicating how predictive answers to that question within that answer class are towards answers to the first question within the set of answers; and
displaying a list of questions whose combined prediction scores from each of its answer classes are highest.

8. The method of claim 1 wherein the method further comprises:
for each cluster of the plurality of clusters, performing another fit operation on the set of answers to the first survey, yielding another prediction score for each question of the first plurality of questions, the prediction score for each question for that cluster indicating how predictive answers to that question are towards that cluster a user's responses are;
displaying a list of questions whose combined prediction scores for each cluster of the plurality of clusters are highest.

9. A system for performing dynamic segmentation, the system comprising a set of one or more computing devices communicatively coupled to a set of client devices over a network, wherein the set of one or more computing devices is configured to:
perform a clustering operation on a set of answers to a first survey from a first plurality of users, the first survey including a first plurality of questions, the clustering operation yielding a plurality of clusters to which the first plurality of users may be assigned;
perform a fit operation on the set of answers to the first survey, yielding a prediction score for each question of the first plurality of questions, the prediction score for each question indicating how predictive answers to that question are towards which cluster of the plurality of clusters a user's responses are;
iterate through the first plurality of questions in order of their prediction scores, beginning with a question having a highest prediction score of the first plurality of questions, and computing a metric for how well a set of questions including all questions already iterated over predicts assignments to the plurality of clusters, stopping iteration once the metric exceeds a threshold minimum metric, yielding a second plurality of questions, the second plurality of questions being fewer than the first plurality of questions;
perform a hyperparameter optimization operation to determine an optimal set of hyperparameters to use to assign membership of a user to a cluster of the plurality of clusters based on that user's answers to the second plurality of questions; and
use the optimal set of hyperparameters to assign membership of a user from a second plurality of users to a cluster of the plurality of clusters based on that user's answers to the second plurality of questions in a second survey.

10. The system of claim 9 wherein performing the fit operation includes operating a gradient-boosting framework for machine learning using an initial set of hyperparameters.

11. The system of claim 9 wherein performing the hyperparameter optimization operation includes performing a grid search using logistic regression over a space of possible hyperparameter values.

12. The system of claim 11 wherein performing the grid search using logistic regression includes using n-fold cross validation.

13. The system of claim 9 wherein:
the set of one or more computing devices is further configured to perform a dimension reduction operation on the set of answers to generate a reduced dimensionality data set, the set of answers having a first dimensionality equal to the first plurality of questions, and the reduced dimensionality data set having a second dimensionality less than the first dimensionality; and
performing the fit operation on the set of answers to the first survey includes performing the fit operation on the reduced dimensionality data set as representative of the set of answers.

14. The system of claim 9 wherein the set of one or more computing devices is further configured to administer the first survey to the first plurality of users, the first survey being divided into a plurality of modules, each module of the plurality of modules including a different subset of the first plurality of questions, wherein administering the first survey to a user of the first plurality of users includes:
sending the questions included within a first module of the plurality of modules to the user;
in response to sending the questions included within the first module, receiving answers to the questions included within the first module from the user;
in response to receiving answers to the questions included within the first module from the user, sending the questions included within a second module of the plurality of modules to the user; and
in response to sending the questions included within the second module, receiving answers to the questions included within the second module from the user.

15. The system of claim 9 wherein the set of one or more computing devices is further configured to:
for a first question of the plurality of questions, perform another fit operation on the set of answers to the first survey, yielding another prediction score for each of a plurality of answer classes for each question of the first plurality of questions aside from the first question, the other prediction score for each such question indicating how predictive answers to that question within that answer class are towards answers to the first question within the set of answers; and
display a list of questions whose combined prediction scores from each of its answer classes are highest.

16. The system of claim 9 wherein the set of one or more computing devices is further configured to:
for each cluster of the plurality of clusters, perform another fit operation on the set of answers to the first survey, yielding another prediction score for each question of the first plurality of questions, the prediction score for each question for that cluster indicating how predictive answers to that question are towards that cluster a user's responses are;
display a list of questions whose combined prediction scores for each cluster of the plurality of clusters are highest.

17. A computer program product comprising a noon-transitory computer-readable storage medium storing instructions, which, when executed by processing circuitry of a set of one or more computing devices, cause the set of one or more computing devices to perform dynamic segmentation by:
performing a clustering operation on a set of answers to a first survey from a first plurality of users, the first survey including a first plurality of questions, the clustering operation yielding a plurality of clusters to which the first plurality of users may be assigned;
performing a fit operation on the set of answers to the first survey, yielding a prediction score for each question of the first plurality of questions, the prediction score for each question indicating how predictive answers to that question are towards which cluster of the plurality of clusters a user's responses are;
iterating through the first plurality of questions in order of their prediction scores, beginning with a question having a highest prediction score of the first plurality of questions, and computing a metric for how well a set of questions including all questions already iterated over predicts assignments to the plurality of clusters, stopping iteration once the metric exceeds a threshold minimum metric, yielding a second plurality of questions, the second plurality of questions being fewer than the first plurality of questions;
performing a hyperparameter optimization operation to determine an optimal set of hyperparameters to use to assign membership of a user to a cluster of the plurality of clusters based on that user's answers to the second plurality of questions; and
using the optimal set of hyperparameters to assign membership of a user from a second plurality of users to a cluster of the plurality of clusters based on that user's answers to the second plurality of questions in a second survey.

18. The computer program product of claim 17 wherein performing the fit operation includes operating a gradient-boosting framework for machine learning using an initial set of hyperparameters.

19. The computer program product of claim 17 wherein performing the hyperparameter optimization operation includes performing a grid search using logistic regression over a space of possible hyperparameter values.

20. The computer program product of claim 19 wherein performing the grid search using logistic regression includes using n-fold cross validation.
